(19) United States
(12) Patent Application Publication
(10) Pub. No.: US 2026/0247450 A1
(43) Pub. Date: Aug. 20, 2026

(54) RANDOM ACCESS CONTROL METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Dongru LI, Dongguan (CN); Yi WANG, Dongguan (CN); Kai WU, Dongguan (CN)

(21) Appl. No.: 19/641,575

(22) Filed: Apr. 8, 2026

Related U.S. Application Data
(63) Continuation of application No. PCT/CN2024/123554, filed on Oct. 9, 2024.

(30) Foreign Application Priority Data
Oct. 9, 2023 (CN) 202311301634.6

(51) Int. Cl. H04W 74/0833

(52) U.S. Cl. CPC H04W 74/0833

(57) ABSTRACT

This application discloses a random access control method and apparatus, a communication device, and a storage medium, and pertains to the field of communication technologies. The random access control method in embodiments of this application includes: receiving, by a first communication device, first information; and performing, by the first communication device, random access based on the first information. The first information includes first configuration information or first control information. The first configuration information is used to indicate configuration information of random access. The first control information is used to trigger the first communication device to initiate random access, or is used to initiate an inventory process.

### CROSS-REFERENCE TO RELATED APPLICATIONS

This application is a continuation of International Patent Application No. PCT/CN2024/123554, filed on Oct. 9, 2024, which claims priority to Chinese Patent Application No. 202311301634.6, filed with the China National Intellectual Property Administration on Oct. 9, 2023 and entitled “RANDOM ACCESS CONTROL METHOD AND APPARATUS, COMMUNICATION DEVICE, AND STORAGE MEDIUM”, which are incorporated herein by reference in their entirety.

### TECHNICAL FIELD

This application pertains to the field of communication technologies, and specifically relates to a random access control method and apparatus, a communication device, and a storage medium.

### BACKGROUND

In an ambient internet of things (AIoT) system, a read/write device, for example, a reader, usually needs to communicate with a plurality of ambient internet of things devices, for example, tag devices (tag). The ambient internet of things device may be connected to the read/write device in a random access manner, and communicate with the read/write device based on a control instruction from the read/write device. However, there is currently no clear solution for implementing random access control for the ambient internet of things device.

### SUMMARY

Embodiments of this application provide a random access control method and apparatus, a communication device, and a storage medium, to implement random access control for a first communication device.

According to a first aspect, a random access control method is provided, including:
receiving, by a first communication device, first information; and
performing, by the first communication device, random access based on the first information.

The first information includes first configuration information or first control information.

The first configuration information is used to indicate configuration information of random access. The first configuration information includes at least one of the following: configuration information of a random access time domain resource; configuration information of a random access frequency domain resource; configuration information of a random access code domain resource; information about a random access type associated with a random access resource; and information about a random access type supported by a cell.

The first control information is used to trigger the first communication device to initiate random access, or is used to initiate an inventory process. The first control information includes random access congestion control information, and the random access congestion control information is used to indicate an available random access resource.

According to a second aspect, a random access control method is provided, including:
sending, by a second communication device, first information.

The first information includes first configuration information or first control information.

The first configuration information is used to indicate configuration information of random access. The first configuration information includes at least one of the following: configuration information of a random access time domain resource; configuration information of a random access frequency domain resource; configuration information of a random access code domain resource; information about a random access type associated with a random access resource; and information about a random access type supported by a cell.

The first control information is used to trigger a first communication device to initiate random access, or is used to initiate an inventory process. The first control information includes random access congestion control information, and the random access congestion control information is used to indicate an available random access resource.

According to a third aspect, a random access control apparatus is provided, including:
a first receiving module, configured to receive first information; and
an access module, configured to perform random access based on the first information.

The first information includes first configuration information or first control information.

The first configuration information is used to indicate configuration information of random access. The first configuration information includes at least one of the following: configuration information of a random access time domain resource; configuration information of a random access frequency domain resource; configuration information of a random access code domain resource; information about a random access type associated with a random access resource; and information about a random access type supported by a cell.

The first control information is used to trigger a first communication device to initiate random access, or is used to initiate an inventory process. The first control information includes random access congestion control information, and the random access congestion control information is used to indicate an available random access resource.

According to a fourth aspect, a random access control apparatus is provided, including:
a first sending module, configured to send first information.

The first information includes first configuration information or first control information.

The first configuration information is used to indicate configuration information of random access. The first configuration information includes at least one of the following: configuration information of a random access time domain resource; configuration information of a random access frequency domain resource; configuration information of a random access code domain resource; information about a random access type associated with a random access resource; and information about a random access type supported by a cell.

The first control information is used to trigger a first communication device to initiate random access, or is used to initiate an inventory process. The first control information includes random access congestion control information, and the random access congestion control information is used to indicate an available random access resource.

According to a fifth aspect, a communication device is provided. The communication device includes a processor and a memory. The memory stores a program or instructions capable of running on the processor, and the program or the instructions are executed by the processor to implement the steps of the method according to the first aspect or implement the steps of the method according to the second aspect.

According to a sixth aspect, a communication device is provided and includes a processor and a communication interface. The communication interface is coupled to the processor, and the processor is configured to run a program or instructions to implement the steps of the method according to the first aspect or implement the steps of the method according to the second aspect.

According to a seventh aspect, a readable storage medium is provided. The readable storage medium stores a program or instructions, and the program or the instructions are executed by a processor to implement the steps of the method according to the first aspect or implement the steps of the method according to the second aspect.

According to an eighth aspect, a wireless communication system is provided and includes a first communication device and a second communication device. The first communication device may be configured to perform the steps of the method according to the first aspect, and the second communication device may be configured to perform the steps of the method according to the second aspect.

According to a ninth aspect, a chip is provided. The chip includes a processor and a communication interface. The communication interface is coupled to the processor, and the processor is configured to run a program or instructions to implement the steps of the method according to the first aspect or implement the steps of the method according to the second aspect.

According to a tenth aspect, a computer program/program product is provided. The computer program/program product is stored in a storage medium. The program/program product is executed by at least one processor to implement the steps of the method according to the first aspect or implement the steps of the method according to the second aspect.

### BRIEF DESCRIPTION OF DRAWINGS

FIG. 1 is a block diagram of a wireless communication system to which an embodiment of this application is applicable;

FIG. 2 is a schematic diagram of a relationship between a reader and a tag device in a related technology;

FIG. 3 is a schematic diagram of a single tag device reply process in a related technology;

FIG. 4 is a schematic diagram of content included in a paging PDSCH in a related technology;

FIG. 5 is another schematic diagram of content included in a paging PDSCH in a related technology;

FIG. 6 is a first topology diagram of ambient internet of things communication in a related technology;

FIG. 7 is a second topology diagram of ambient internet of things communication in a related technology;

FIG. 8 is a third topology diagram of ambient internet of things communication in a related technology;

FIG. 9 is a fourth topology diagram of ambient internet of things communication in a related technology;

FIG. 10 is a fifth topology diagram of ambient internet of things communication in a related technology;

FIG. 11 is an implementation flowchart of a random access control method according to an embodiment of this application;

FIG. 12 is a schematic diagram of a random access resource according to an embodiment of this application;

FIG. 13 is another schematic diagram of a random access resource according to an embodiment of this application;

FIG. 14 is a schematic diagram of a random access control procedure according to an embodiment of this application;

FIG. 15 is an implementation flowchart of another random access control method according to an embodiment of this application;

FIG. 16 is a schematic diagram of a structure of a random access control apparatus corresponding to FIG. 11 according to an embodiment of this application;

FIG. 17 is a schematic diagram of a structure of a random access control apparatus corresponding to FIG. 15 according to an embodiment of this application;

FIG. 18 is a schematic diagram of a structure of a communication device according to an embodiment of this application;

FIG. 19 is a schematic diagram of a structure of a terminal according to an embodiment of this application;

FIG. 20 is a schematic diagram of a structure of a network-side device according to an embodiment of this application; and

FIG. 21 is a schematic diagram of a structure of another network-side device according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that terms used in this way are interchangeable under appropriate circumstances, so that the embodiments of this application can be implemented in an order other than that illustrated or described herein. Moreover, the terms “first” and “second” typically distinguish between objects of a same category rather than limiting a quantity of objects. For example, there may be one or more first objects. In addition, “or” in this application represents at least one of connected objects. For example, “A or B” includes three solutions: a solution 1: including A and not including B; a solution 2: including B and not including A; and a solution 3: including both A and B. The character “/” usually represents an “or” relationship between associated objects.

The term “indication” in this application may be either a direct indication (or an explicit indication) or an indirect indication (or an implicit indication). The direct indication may be understood as follows: A sender explicitly notifies, in a sent indication, a receiver of specific information, an operation that needs to be performed, a requested result, or other content. The indirect indication may be understood as follows: The receiver determines corresponding information based on the indication sent by the sender, or performs determining based on the indication sent by the sender, and determines, based on a determining result, the operation that needs to be performed, the requested result, or the like.

It should be noted that a technology described in the embodiments of this application is not limited to a long term evolution (LTE)/LTE-advanced (LTE-A) system, and may be further applied to another wireless communication system, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, or another system. The terms “system” and “network” are often used interchangeably in the embodiments of this application. The technology described may be used in the systems and radio technologies described above, and may be further used in other systems and radio technologies. The following describes a new radio (NR) system for illustrative purposes, and NR terms are used in most of the following descriptions. However, these technologies are also applicable to systems such as a 6th generation (6G) communication system other than the NR system.

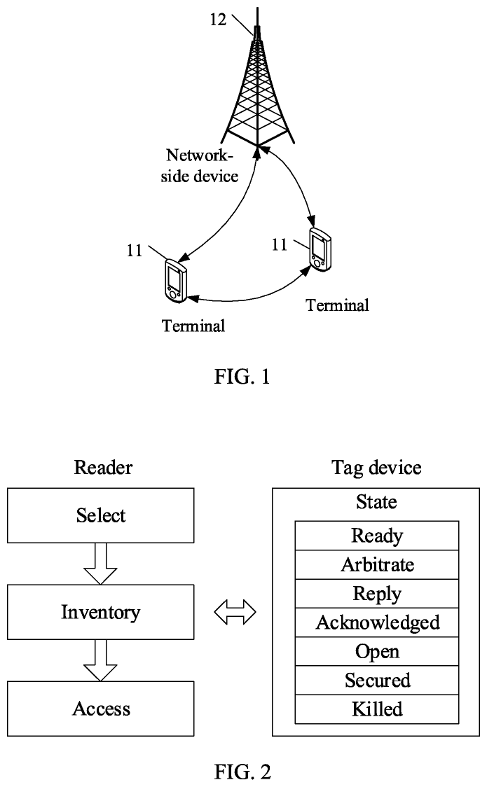

FIG. 1 is a block diagram of a wireless communication system to which an embodiment of this application is applicable. The wireless communication system includes a terminal 11 and a network-side device 12.

The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or a piece of furniture), a game console, a personal computer (PC), a teller machine, a self-service machine, or another terminal-side device. The wearable device includes a smartwatch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in this embodiment of this application.

The network-side device 12 may include an access network device or a core network device. The access network device may also be referred to as a radio access network (RAN) device, a radio access network function, or a radio access network unit. The access network device may include a base station, a wireless local area network (WLAN) access point (AS), a wireless fidelity (WiFi) node, and the like. The base station may be referred to as a NodeB (NB), an evolved NodeB (eNB), a next generation NodeB (gNB), a new radio NodeB (NR Node B), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the art. The base station is not limited to a specific technical term, provided that same technical effects are achieved. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, only a core network device in the NR system is used as an example for description, and a specific type of the core network device is not limited. The core network device is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, only a core network device in the NR system is used as an example for description, and a specific type of the core network device is not limited.

For ease of understanding, an application scenario of and related technologies and concepts in the embodiments of this application are first described.

I. Application Scenario of the Embodiments of this Application

The technical solutions provided in the embodiments of this application may be applied to an ambient internet of things communication scenario. For example, the technical solutions may be applied to item counting, logistics inventory, fire warning, and other scenarios. For another example, the technical solutions may be applied to a radio frequency identification (RFID) technology-specific reader, a Wi-Fi transmission scenario, a cellular network transmission scenario, a next-generation mobile communication scenario, or the like.

### II. Information Transmission Between a Reader and a Tag Device in RFID

As shown in FIG. 2, the reader may send signaling of types such as select, inventory, and access to the tag device. A state on a tag device side may include ready, arbitrate, reply, acknowledged, open, secured, killed, or the like.

An operation instruction from the reader is shown in Table 1:

TABLE 1

| Operation | | |
|---|---|---|
| type | Instruction | Function |
| Select | Select | Selects a target tag to be inventoried |
| Inventory | Query | Starts an inventory action/procedure |
| | | Generates a random number to determine |
| | | a reply time |
| | Query Adjust | Adjusts an original slot number of the tag |
| | QueryRep | The tag decreases the slot number of the |
| | | tag |
| | EPC | Instruction with which the reader replies to |
| | acknowledgment | the tag |
| | (ACK) | |
| | NAK | Instruction sent by the reader |
| | | The tag returns to the arbitrate state |
| Access | Req_RN | Requires the tag to generate a random |
| | | number |
| | Read | Reads data from a specific location in a |
| | | tag memory |
| | Write | Writes data into the tag memory |
| | Kill | No longer replies to any reader |
| | | Prevents privacy leakage |
| | | The tag can no longer be used |
| | Lock | The tag can no longer perform a write |
| | | action |
| | | Prevents arbitrary data tampering |
| | Access (optional) | Transitions the tag from the open state to |
| | | the secured state when the tag has a |
| | | password |
| | BlockWrite | Writes a plurality of blocks at a time |
| | (optional) | |
| | Block Erase | Erases a plurality of blocks from a single |
| | (optional) | tag memory |

A state of the tag device is shown in Table 2:

TABLE 2

| Tag state | Description |
|---|---|
| Ready | Not in a current inventory operation |
| Arbitrate | The tag is currently in an inventory operation |
| | Indicates that a slot number is not zero, indicating that |
| | the tag is still waiting |
| Reply | Generates a 16-bit random number for the reader |
| | Enters the acknowledged state when an ACK message is |
| | received |
| | Returns to the arbitrate state when no ACK message is |
| | received |
| Acknowledged | Enters any state other than the killed state from this state |
| Open | A tag with a non-zero password enters this state when |
| | receiving a Req_RN instruction while in the |
| | acknowledged state |
| Secured | A tag with a zero password enters this state when |
| | receiving a Req_RN instruction from the reader while in |
| | the acknowledged state |
| Killed | Permanently unavailable |

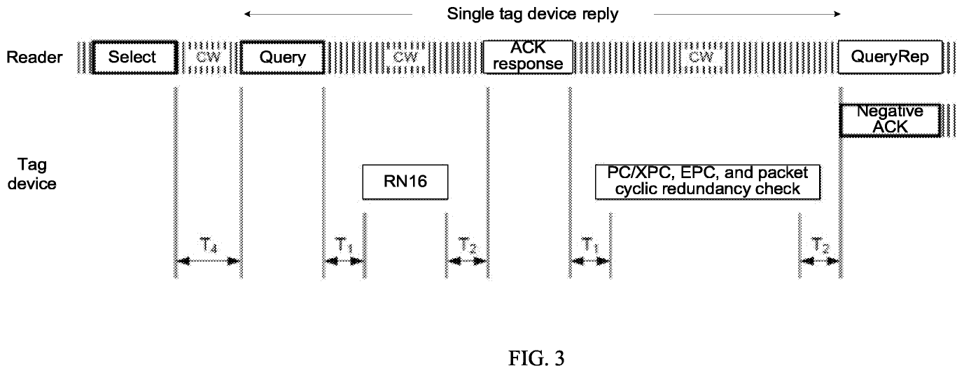

FIG. 3 is a flowchart of sending and receiving by a tag device. In an inventory mode, a reader selects a tag device, and sends a query instruction. The tag device responds with a reply, and generates a 16-bit random number for the reader. The reader then sends the random number sequence to the tag device by using an ACK instruction. The tag device sends related data, for example, a protocol control (PC)/extended protocol control (XPC), an electronic product code (EPC), and packet cyclic redundancy check (Packet CRC), to the reader. If the EPC is valid, the reader may send a QueryRep command or another command. If the EPC is invalid, the reader may send a NAK. A process from sending of the query instruction by the reader to receiving, by the reader, of the related data sent by the tag device is a single tag device reply process.

### III. Contention-Based Communication Process in a Backscatter Communication System

The backscatter communication system is an ambient internet of things system. In an existing backscatter communication system, a reader usually can receive a backscatter signal only from one tag device at a same moment. For example, in an RFID inventory procedure, the reader indicates a value Q when sending a control command to start the inventory procedure. The tag device randomly selects a value q from locally generated values {0, . . . , 2\hat{ }Q−1}. A tag device whose current random number is 0 responds to the control command from the reader and performs backscatter signal transmission. A tag device whose current random number is not 0 temporarily does not perform backscatter signal transmission. After completing communication with the tag device whose random number is 0, the reader may continue to send a control command, for example, QueryRep. For example, the tag device is indicated to decrease the generated random number by 1. A tag device whose random number is decreased to 0 responds to the control command and performs backscatter transmission.

The foregoing procedure is a random multiple access procedure. There is a possibility that a plurality of tag devices locally generate a same random number, and consequently the plurality of tag devices simultaneously perform backscatter transmission at a specific moment. In this case, there is a high probability that the reader cannot detect a backscatter signal from any tag device, and does not send feedback based on the backscatter signal from the tag device to the tag device. In this case, these tag devices continue to receive a control command from the reader, and wait for a new opportunity for backscatter transmission. Therefore, when sending a control command, the reader should select a proper Q value, and can gradually adjust the Q value in an inventory process, to reduce a collision probability during communication with a plurality of tag devices. Certainly, this also means that it takes a longer time to complete communication with a plurality of tag devices.

In an existing solution design, if backscatter signal transmission parameters of a plurality of tag devices at a same moment are the same, backscatter signals from the plurality of tag devices cannot be detected on a reader side at the same moment, adversely affecting efficiency of inventorying the plurality of tag devices.

### IV. Classification and Characteristics of Ambient Internet of Things Devices

The ambient internet of things device is characterized based on an energy storage capacity of the ambient internet of things device and a capability of generating a radio frequency signal for transmission. The ambient internet of things device has one of the following energy storage capabilities:

Storage capacity 1: There is no energy storage capability.

Storage capacity 2: Energy can be stored up to E1 or E2 joules, where there is a possibility that E1=E2.

Storage capacity 3: Energy can be stored up to E2 joules.

Based on these storage capacities, the study considers the following group of ambient internet of things devices:

Device A: The device has no energy storage capability and no independent signal generation/amplification capability, and performs backscatter transmission.

Device B: The device has an energy storage capability and no independent signal generation capability, and performs backscatter transmission. Use of stored energy may include amplification of a reflected signal.

Device C: The device has an energy storage capability and an independent signal generation capability, that is, has an active radio frequency component for transmission.

### V. Ambient Internet of Things Data/Service Type

Device-originated (DO) indicates that a data flow originates from an ambient internet of things device (for example, a tag device in RFID).

Device-terminated (DT) indicates that a data flow is transmitted to the ambient internet of things device.

Data flows originating from the ambient internet of things device, that is, DO data, may be further classified as follows:

Device-originated-Auto (DO-A) data transmission: For example, a large quantity of sensors are connected, and these sensors collect and automatously report information about an environment, devices, and living beings when necessary.

DO-DT triggered (Device-originated-device-terminated triggered, DO-DTT) data transmission: For example, asset identification, status reporting, and tracking are all downlink (DL)-triggered reporting. A read/write device collects data from the ambient internet of things device by triggering an inventory program. Because the data is generated/initiated in the ambient internet of things device, the service should be considered as a DO service initiated by the ambient internet of things device by triggering by a command sent by the read/write device.

### VI. Paging Process

In a 5G NR system, a terminal may use discontinuous reception (DRX) in an idle or inactive state to save power. The terminal monitors a paging occasion (PO) in each discontinuous reception cycle (DRX cycle), to obtain paging downlink control information (DCI). A base station configures a parameter of a physical downlink control channel (PDCCH) monitoring occasion (MO) set for paging. The terminal calculates a system frame number (SFN) of a paging frame (PF) in which the PO is located and an index number of the PO based on formulas, and determines a location of the PO from the PDCCH MO set.

A formula for determining the system frame number SFN of the PF is (SFN+PF_offset) mod T=(T div N)*(UE_ID mod N).

A formula for determining the index number i_s of the PO is i_s=floor (UE_ID/N) mod Ns.

Herein, T is a DRX cycle of the terminal, N is a quantity of PFs in one cycle T, PF_offset is an offset value of a PF start point, UE_ID is determined based on a unique identifier, namely, a short-temporary mobile subscriber identity (s-TMSI), of the terminal, and Ns represents a quantity of POs in one PF.

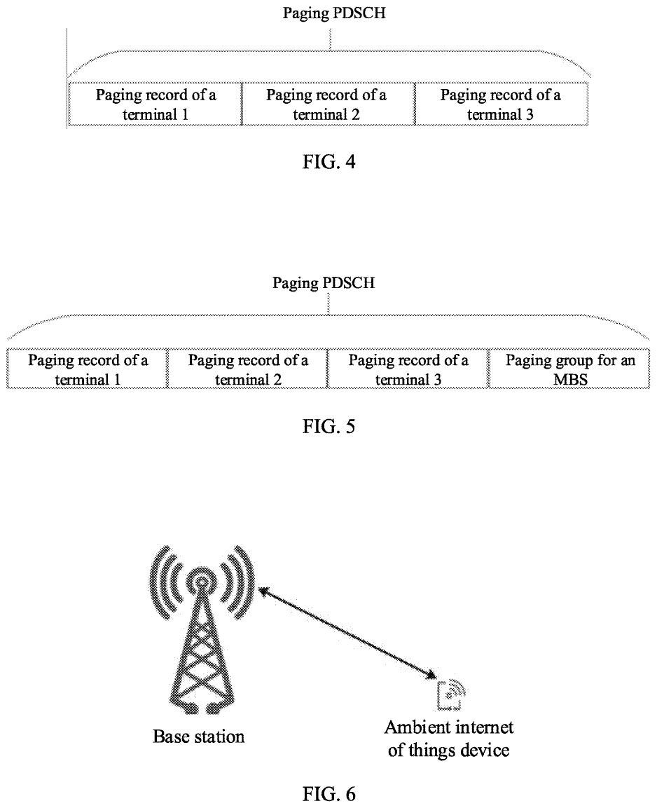

The terminal receives a paging PDSCH by receiving the paging DCI. The paging PDSCH carries a paging message. The paging message may include one or more paging records, and each paging record corresponds to one terminal. As shown in FIG. 4, a paging PDSCH includes a paging record of a terminal 1, a paging record of a terminal 2, and a paging record of a terminal 3. One or more terminals that are paged by a same paging message correspond to a same PO, that is, one or more terminals that are paged by a same paging message correspond to a same PF and i_s. In addition, the paging message may further include paging group information for a multimedia broadcast service (MBS). As shown in FIG. 5, a paging PDSCH includes a paging record of a terminal 1, a paging record of a terminal 2, a paging record of a terminal 3, and a paging group for an MBS. The paging group information is represented by a temporary mobile group identity (TMGI), including a public land mobile network (PLMN) and a service ID.

### VII. Inventory Round/Inventory Procedure/Inventory Process

The inventory round is started by a query command and is a cycle terminated by a subsequent query command (used to initiate a new inventory round), a select command, or a challenge command.

### VIII. Ambient Internet of Things Communication Scenario Topology

A network architecture of ambient internet of things communication is shown in FIG. 6 to FIG. 10.

As shown in FIG. 6, a network-side device, such as a base station, and an ambient internet of things device, such as a tag device directly perform bidirectional communication. The network-side device sends a carrier signal or control signaling to the ambient internet of things device, and receives a backscatter signal from the ambient internet of things device. The network-side device that sends the carrier signal or the control signaling to the ambient internet of things device and the network-side device that receives the backscatter signal from the ambient internet of things device may be the same or different.

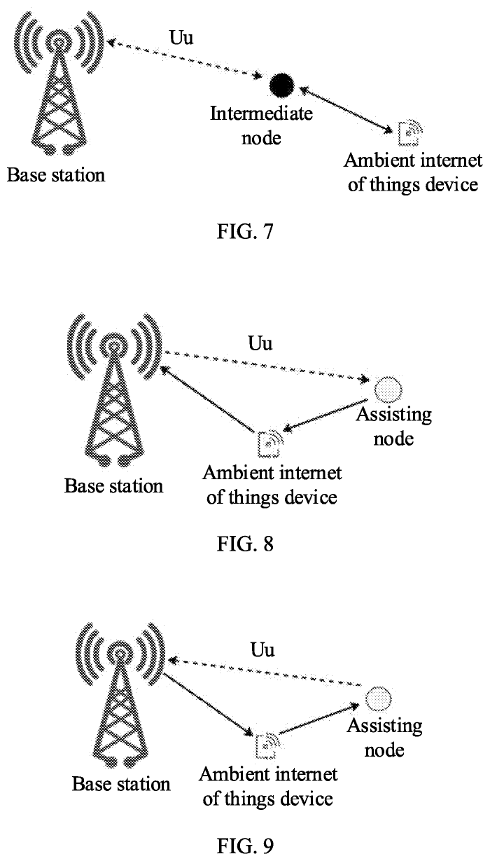

As shown in FIG. 7, an intermediate node is deployed between a network-side device, such as a base station, and an ambient internet of things device. The ambient internet of things device and the intermediate node perform bidirectional communication, and the intermediate node and the network-side device communicate through a Uu interface, to transmit information between the network-side device and the ambient internet of things device. The intermediate node may be an integrated access backhaul node (IAB), a terminal, a repeater, or the like.

As shown in FIG. 8, an ambient internet of things device sends data/signaling to a network-side device, such as a base station, and receives data/signaling from an assisting node. As shown in FIG. 9, an ambient internet of things device receives data/signaling from a network-side device, such as a base station, and sends data/signaling to an assisting node. In the topologies shown in FIG. 8 and FIG. 9, the assisting node communicates with the network-side device through a Uu interface, and the assisting node may be an IAB, a terminal, a repeater, or the like.

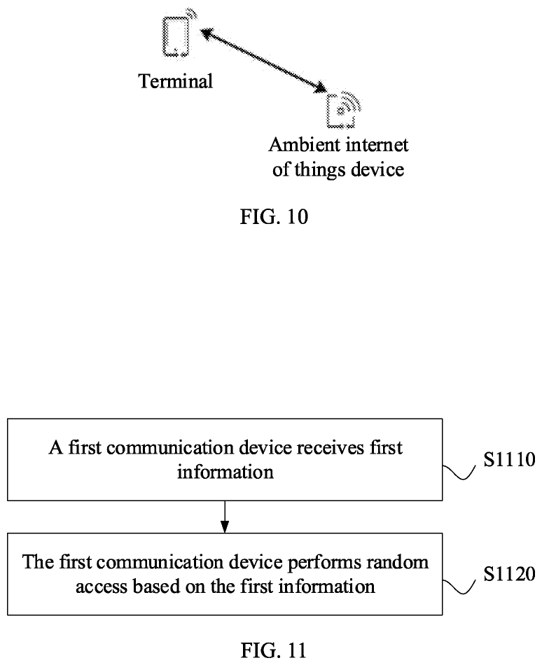

As shown in FIG. 10, an ambient internet of things device and a terminal perform bidirectional communication, and communication between the terminal and the ambient internet of things device includes ambient internet of things data or signaling.

The foregoing describes the application scenario of and the related technologies and concepts in the embodiments of this application. With reference to the accompanying drawings, the following describes, by using some embodiments and application scenarios thereof, in detail the random access control method provided in the embodiments of this application.

FIG. 11 is an implementation flowchart of a random access control method according to an embodiment of this application. The method includes the following steps.

S1110: A first communication device receives first information.

S1120: The first communication device performs random access based on the first information.

The first information includes first configuration information or first control information.

The first configuration information is used to indicate configuration information of random access.

The first control information is used to trigger the first communication device to initiate random access, or is used to initiate an inventory process.

According to the method provided in this embodiment of this application, after receiving the first information, the first communication device performs random access based on the first information. The first information includes the first configuration information or the first control information. The first configuration information is used to indicate the configuration information of random access. The first control information is used to trigger the first communication device to initiate random access, or is used to initiate an inventory process. Configuration or triggering of random access by the first communication device is implemented by using the first information. This helps reduce a collision in inventorying the first communication device, or reduce a random access collision of the first communication device, thereby improving inventory efficiency.

It should be noted that receiving in this embodiment of this application may be understood as obtaining. In addition, random access in this embodiment of this application may be understood as sending of uplink information (for example, inventory feedback information) by the first communication device to a second communication device. In an embodiment, the first communication device receives the first control information, and the first communication device performs random access based on the first control information. That the first communication device performs random access may be understood as that the first communication device makes inventory feedback or an inventory response.

Optionally, in an embodiment, the first control information is used to initiate an inventory procedure/inventory process/inventory round. Further, the inventory process initiated by using the first control information is terminated when next first control information or other specific control information is received.

It should be noted that in addition to the foregoing functions and uses of triggering random access or initiating an inventory process, the first control information may further have other functions and uses. This is not limited herein.

In this embodiment of this application, the first communication device is a target first communication device that is to be inventoried this time and that is determined based on an indication of the first control information or by using an indication of other control information before the first control information. The first communication device determines whether the first communication device is one of target first communication devices to be inventoried. Only the target first communication device performs random access or makes inventory feedback based on the indication of the first control information. Details are not described below.

In this embodiment of this application, the second communication device may send the first information, and the first communication device receives the first information, and performs random access based on the received first information. The first communication device may be the ambient internet of things device described in the background, for example, a tag device (tag). The second communication device may be a network-side device or an intermediate node device. The network-side device is, for example, a base station (gNB) or a core network device. The intermediate node device is, for example, a terminal (UE) or another form of terminal device, for example, a reader.

In an embodiment, the first information may include the first configuration information or the first control information. A part or all of information included in the first information may be agreed upon in a protocol, or may be configured by the network-side device. For example, some information in the first information is agreed upon in a protocol, and the first communication device obtains the some information based on the protocol. The first configuration information is used to indicate the configuration information of random access. The first control information is used to trigger the first communication device to initiate random access, or is used to initiate an inventory process. Initiating an inventory process may also be understood as starting an inventory cycle, an inventory round, or a random access procedure.

In an embodiment, the first communication device is a device selected for inventory in this inventory process.

In some embodiments of this application, the first configuration information may include at least one of the following:
(1) Configuration information of a random access time domain resource

The random access time domain resource may include at least one of a period of the random access time domain resource, a time domain location of a random access occasion, duration of each random access occasion, a quantity of random access occasions included in each period, and the like. In an embodiment, the first communication device selects a specific random access occasion for random access. The random access occasion may be understood as a random access time unit.
(2) Configuration information of a random access frequency domain resource

The random access frequency domain resource may include at least one of a carrier bandwidth for random access, a carrier frequency, a bandwidth part (BWP) in which random access is performed, a frequency domain resource in a carrier or a bandwidth part, a frequency domain location of a random access occasion, a frequency domain resource size of each random access occasion, and the like.
(3) Configuration information of a random access code domain resource
(4) Information about a random access type associated with a random access resource

In an embodiment, the first configuration information may include configuration information of a random access resource corresponding to one or more different random access types. The random access resource includes a random access time domain resource, a random access frequency domain resource, or a random access code domain resource. The random access type associated with the random access resource is a random access type corresponding to configuration information of the random access time domain resource, the random access frequency domain resource, or the random access code domain resource.
(5) Information about a random access type supported by a cell

Optionally, random access types supported by different cells may be the same or different. If the first communication device needs to perform inventory access in a cell, random access needs to be performed based on a random access type supported by the cell. That is, the first communication device is prohibited from performing random access by using a random access type not supported by the cell.

In an embodiment, the first configuration information is used to configure a random access occasion. One or more random access occasions may be obtained through division based on at least one of the random access time domain, frequency domain, and code domain resources. The first communication device selects a target random access occasion, and initiates random access on the random access occasion. The random access occasion may be understood as a unit for performing random access.

Further, the first configuration information further includes a pattern of one or more random access occasions. For example, the first configuration information configures a group of (a plurality of or different) random access occasions for time division multiplexing (TDM), frequency division multiplexing (FDM), or the like between each other.

In this embodiment of this application, the first configuration information may include at least one of the foregoing content, and the first communication device may learn of related configuration of random access based on the first configuration information, to perform random access based on the related configuration.

Optionally, the random access type may include at least one of the following:
a manner of initiating random access;
a service type of random access; and
a session type of random access.

The manner of initiating random access may include random access automatously initiated by the first communication device or random access initiated by the first communication device by triggering. The service type of random access includes random access of an inventory service or random access of a non-inventory service.

In an embodiment, the random access automatously initiated by the first communication device is, for example, a DO-A manner. The random access initiated by the first communication device by triggering is, for example, a DT manner. In another embodiment, the non-inventory service includes a sensor service, a positioning service, or a command service.

The session type of random access means a session channel identifier associated with random access. For example, random access is associated with session ID1. For another example, different session channels have different transmission or communication characteristics, for example, have different channel priorities or service priorities or are associated with different second communication devices.

Related configuration of random access is performed by using the first configuration information, to help effectively plan and control random access by the first communication device.

Optionally, the configuration information of the random access resource may include resource configuration information for different random access types, for example, includes resource configuration information used to automatously initiate random access by the first communication device, or includes resource configuration information used to initiate random access by the first communication device by triggering.

In some embodiments of this application, the first control information may include random access congestion control information, and the random access congestion control information is used to indicate an available random access resource.

Optionally, the available random access resource indicated in the random access congestion control information may be a part or all of the random access resource configured in the first configuration information. For example, the first control information indicates a time range in which the available random access resource is located or a frequency domain range in which the available random access resource is located.

It may be understood that in another embodiment, the available random access resource may be that based on the random access resource configured in the first configuration information, a part of the random access resource is further indicated by using the first control information, and is used as the available random access resource (associated with the first control information).

Optionally, the available random access resource is a random access resource available in the inventory process triggered by the first control information.

In this embodiment of this application, the available random access resource is indicated to the first communication device, so that the first communication device can perform random access based on the available random access resource indicated in the random access congestion control information. This can effectively reduce an inventory collision and can improve inventory efficiency.

In some embodiments of this application, a part or all of the available random access resource is used for retransmission random access or initial transmission random access.

Optionally, a part or all of the available random access resource indicated in the random access congestion control information may be used only for retransmission random access, only for initial transmission random access, or for both initial transmission random access and retransmission random access, or one part is used for initial transmission random access, and the other part is used for retransmission random access. For example, last M random access resources in the available random access resource indicated in the random access congestion control information may be used for both retransmission random access and initial transmission random access. For another example, last M random access resources in the available random access resource indicated in the random access congestion control information are used only for retransmission random access. This is not limited herein.

It may be understood that when performing initial transmission random access, the first communication device can select only a random access resource that can be used for initial transmission random access. Correspondingly, when performing retransmission random access, the first communication device can select only a random access resource that can be used for retransmission random access.

It should be noted that the initial transmission random access is random access (or inventory feedback) initiated by the first communication device for the first time in an inventory process, and the retransmission random access is random access (or inventory feedback) reinitiated by the first communication device in an inventory process, that is, random access not initiated for the first time. Further, an inventory process is a random access process or an inventory process triggered when the first communication device receives the first control information. In an embodiment, a plurality of times of random access respectively initiated by the first communication device in random access processes or inventory processes triggered by different first control information are not retransmission random access.

In this embodiment of this application, the first communication device may determine an available random access resource range based on the available random access resource indicated in the random access congestion control information, and perform, on the available random access resource, random access or inventory feedback triggered by this first control information.

In some embodiments of this application, the random access congestion control information may include at least one of time domain congestion control information, frequency domain congestion control information, or code domain congestion control information.

Optionally, the time domain congestion control information may include at least one of the following:

(1) Random access index: The random access index is used to indicate a random access time domain range. If the random access index is Q, an optional/available random access time domain range is (0~2\hat{ }Q−1) random access time units. Optionally, the first communication device may determine, in the random access time domain range, a target time/occasion for initiating random access.

(2) Inventory time window information: The inventory time window information is used to indicate a time range for initiating random access. Optionally, a length unit of an inventory time window may be a slot, a symbol, or an occasion. The first communication device may determine, in the inventory time window, a target time/occasion for initiating random access.

(3) Backoff time information: The backoff time information is used to indicate a backoff time range for initiating random access. Optionally, the first communication device determines, in the backoff time range, a backoff time for initiating random access. After the backoff time, the first communication device may initiate random access. It may be understood that the backoff time of random access may be understood as a time for delaying initiation of random access.

The time domain congestion control information includes at least one of the foregoing content. Based on the time domain congestion control information, the first communication device may select a target random access time domain resource or a target random access occasion associated with the first communication device, and initiate random access on the target random access time domain resource or the target random access occasion, so that effective congestion control can be implemented in time domain for initiating random access by the first communication device.

Optionally, a time length occupied by a random access occasion (for example, a random access time domain unit or granularity) may be configured by the network-side device or agreed upon in a protocol, for example, X slots, X symbols, or X time units. Similarly, a frequency domain size occupied by the random access occasion may also be configured by the network-side device or agreed upon in a protocol, for example, M resource blocks (RBs)/physical resource blocks (PRBs) or M resource elements (REs).

In a possible implementation, a random access time domain resource indicated in the random access index, the inventory time window information, or the backoff time information corresponds to a quantity of random access time units, for example, 2\hat{ }Q−1 slots. In another possible implementation, a random access time domain resource indicated in the random access index, the inventory time window information, or the backoff time information corresponds to a quantity of random access occasions (ROs). For example, the available random access time domain resource range is Q determined random access occasions. In addition, the available random access time domain resource range starts with respect to a specific time reference point, for example, an end location of a time unit in which the first communication device receives the first control information (a start location of a next time unit of the time unit in which the first control information is received), or an end location separated by a time interval from an end location of a time unit in which the first communication device receives the first control information.

Optionally, the frequency domain congestion control information may include a random access frequency domain resource range. In an embodiment, the first communication device may select, in the random access frequency domain resource range, a target random access frequency domain resource associated with the first communication device, for example, a carrier or a bandwidth part, and initiate random access on the target random access frequency domain resource, to effectively control random access by the first communication device in frequency domain. For example, the random access frequency domain resource range may be one or more carrier frequency bands or bandwidths.

Optionally, the code domain congestion control information may include a random access code domain resource range. The first communication device may select, in the random access code domain resource range, a target random access code domain resource associated with the first communication device, and initiate random access on the target random access code domain resource, to effectively control random access by the first communication device in code domain.

In some embodiments of this application, the first communication device may determine a random access resource of the first communication device with reference to the first configuration information and random access congestion control information. For example, the first configuration information configures a random access resource, a resource pattern, and the like. The first device further determines, based on the random access congestion control information, a random access resource that is optional in a current inventory process. This is equivalent to that the random access congestion control information further narrows a range of the random access resource based on the first configuration information.

In some embodiments of this application, that the first communication device performs random access based on the first information may include the following steps:

Step 1: The first communication device determines the available random access resource based on the random access congestion control information.

Step 2: The first communication device determines a target random access resource from the available random access resource in a first manner.

Step 3: The first communication device initiates random access on the target random access resource.

The first manner includes a random selection manner or a manner associated with an identifier of the first communication device.

In this embodiment of this application, the first information includes the first configuration information or the first control information. The first configuration information is used to indicate the configuration information of random access. The first control information is used to trigger the first communication device to initiate random access, or is used to initiate an inventory process. The first control information may include the random access congestion control information, and the random access congestion control information may indicate the available random access resource.

After receiving the first information, the first communication device may determine the available random access resource based on the random access congestion control information, and determine the target random access resource from the available random access resource in the first manner. The first manner may be a random selection manner, and the target random access resource is randomly selected from the available random access resource. Alternatively, the first manner may be a manner associated with the identifier of the first communication device. For example, the target random access resource is selected based on the identifier of the first communication device mod the random access time domain range or the random access frequency domain range or the random access code domain range being equal to 0.

After determining the target random access resource, the first communication device initiates random access on the target random access resource. Because the target random access resource is determined based on the available random access resource indicated in the random access congestion control information, a probability of an inventory collision is adjusted based on the congestion control indication, thereby effectively avoiding an inventory collision or improving inventory efficiency.

In some embodiments of this application, the first information may further include retransmission random access information, and the retransmission random access information may include at least one of the following:
(1) Information about a retransmission random access resource: The information about the retransmission random access resource is used to indicate a resource for retransmission random access.

Optionally, the retransmission random access resource may be separately configured with an initial transmission random access resource, may be configured based on an initial transmission random access resource, or may be jointly configured with an initial transmission random access resource.

Optionally, the retransmission random access resource may include a retransmission random access time domain resource, a retransmission random access frequency domain resource, or a retransmission random access code domain resource.

Optionally, the retransmission random access resource may include a remaining random access resource, other than a resource used for initial transmission random access, in a random access resource corresponding to a current inventory process. It should be noted that this is for each first communication device. In the current inventory process, after the first communication device fails to initiate initial transmission random access, the first communication device may perform retransmission random access by using a remaining random access resource other than a random access resource used for initiating random access for the first time.

Optionally, the retransmission random access resource may be a specific group of random access resources in the available random access resource indicated in the random access congestion control information. For example, last M random access time units or random access occasions in the available random access time domain resource determined based on the random access index Q or the inventory time window indicated in the random access congestion control information may be used for retransmission random access. Further, the M random access time units or random access occasions may be used only for retransmission random access, or may be used for both retransmission random access and initial transmission random access. A case in frequency domain is similar to this. For example, in the available random access frequency domain resource indicated in the random access congestion control information, a specific frequency domain resource may be used for retransmission random access.

In an embodiment, through configuration of the retransmission random access resource information, in order not to increase an initial transmission random access collision probability of the first communication device, retransmission random access by the first communication device may be offloaded to a specific resource for retransmission random access to perform retransmission random access.
(2) Information about a backoff time of retransmission random access: The information about the backoff time of retransmission random access is used to indicate a backoff time range for initiating retransmission random access.

Optionally, the first communication device determines a retransmission random access backoff time of the first communication device in the backoff time range of retransmission random access, and initiates retransmission random access on a time domain resource available for retransmission random access after the retransmission random access backoff time.

Optionally, the backoff time of retransmission random access may be a time domain offset or a time interval.

Optionally, a start reference point of the backoff time of retransmission random access may include a start or end location of a resource set for initial transmission random access, an end location of a time unit in which initial transmission random access by the first communication device fails, or an end location of a random access response time window.

The random access response time window starts from initiation of a random access response by the first communication device. Optionally, a size of the random access response time window is configured by the network-side device or agreed upon in a protocol.

For example, if the backoff time range of retransmission random access is 0 ms to 10 ms, the first communication device that needs to perform retransmission random access may select a backoff time from the backoff time range, for example, 5 ms, and initiate retransmission random access after the 5-ms backoff time. A reference point of the 5-ms backoff time may be an end location of a random access response time window associated with initiation of initial transmission random access by the first communication device.
(3) Information about whether to fall back to a target random access manner

Optionally, the target random access manner includes a manner in which the first communication device automatously initiates random access. If fallback to the target random access manner is indicated, when N times of random access fail to be initiated, the first communication device falls back to the target random access manner for access. That is, the first communication device performs random access by automatously initiating random access. A value of N may be configured by the network-side device, for example, indicated by using the first configuration information or the first control information, or agreed upon in a protocol. N is a positive integer greater than or equal to 1.

Optionally, whether to fall back to the target random access manner may be agreed upon in a protocol. In an embodiment, it is agreed upon in a protocol that when the N times of random access fail to be initiated, the first communication device falls back to performing access in the target random access manner.

Optionally, the first communication device may initiate random access on a random access resource corresponding to the target random access manner. The random access resource corresponding to the target random access manner may be configured by the network-side device.
(4) Information about whether it is allowed to initiate retransmission random access in an inventory process

Optionally, if it is agreed upon in a protocol that or the network-side device configures that it is allowed to initiate retransmission random access in an inventory process, the first communication device may initiate retransmission random access in the current/this inventory process when initial transmission random access fails. If it is not allowed to initiate retransmission random access in an inventory process, the first communication device directly exits the current/this inventory process when initial transmission random access fails.

In the foregoing embodiment, the first information further includes the retransmission random access information. The first communication device may determine (1) whether to perform retransmission random access, (2) how to perform retransmission random access, and (3) a condition for performing retransmission random access. This helps improve inventory efficiency and improve random access efficiency and accuracy.

Optionally, the information about the retransmission random access resource or the information about the backoff time of retransmission random access may be carried together with the first configuration information in higher layer configuration information, such as a radio resource control (RRC) or MAC control element (MAC CE), or may be carried together with the first control information in dynamic indication information, such as downlink control information (DCI).

Optionally, the information about the retransmission random access resource or the information about the backoff time of retransmission random access may be carried in the first configuration information or the first control information.

Optionally, the information about whether to fall back to the target random access manner and the information about whether it is allowed to initiate retransmission random access in an inventory process may be agreed upon in a protocol or configured by the network-side device.

In this embodiment of this application, the first control information includes the random access congestion control information. Before the first communication device initiates random access, random access congestion control is implemented through allocation of access resources. An inventory collision may be effectively avoided. In addition, allocation of a random access resource pool may be understood.

In some embodiments of this application, after the first communication device performs random access based on the first information, the method may further include the following step:

When random access fails, the first communication device exits the inventory process initiated by triggering by the first control information, or the first communication device initiates retransmission random access.

In this embodiment of this application, random access performed by the first communication device based on the first information may be considered as initial random access. There may be two results: Random access succeeds, and random access fails. When random access succeeds, the first communication device may continue to perform subsequent transmission. When random access fails, the first communication device may exit, based on the retransmission random access information or a protocol agreement, the inventory process initiated by triggering by the first control information, that is, exit the current/this inventory process. Alternatively, the first communication device may initiate retransmission random access based on the retransmission random access information or a protocol agreement. This helps reduce an inventory delay and improve inventory efficiency and random access accuracy.

In some embodiments of this application, that the first communication device initiates retransmission random access may include the following step:

The first communication device falls back to initiating retransmission random access in the target random access manner.

In this embodiment of this application, when random access fails, the first communication device may fall back, based on the retransmission random access information or a protocol agreement, to initiating retransmission random access in the target random access manner. The target random access manner includes a manner in which the first communication device automatously initiates random access.

Optionally, when N times of random access fail to be initiated, the first communication device falls back to initiating retransmission random access in the target random access manner, where N is a positive integer greater than or equal to 1.

In the current inventory process, when the N times of random access fail to be initiated, the first communication device may fall back to initiating retransmission random access in the target random access manner. N may be configured by the network-side device or agreed upon in a protocol.

The first communication device falls back to initiating retransmission random access in the target random access manner, which helps improve a random access success rate and improve inventory efficiency.

Optionally, the first communication device may perform retransmission random access on a remaining random access resource in the random access resource corresponding to the current inventory process initiated by the first control information.

Optionally, the remaining random access resource is a random access resource separated by a specific time interval from a time unit in which random access fails for the first time. For example, the specific time interval is a random access response time window.

Optionally, if the first control information indicates the available random access resource by using the random access index Q, the inventory time window information, or the like, the remaining random access resource does not exceed a range of the available random access resource.

For example, if a random access resource allocated to initial transmission random access is a time window, the remaining random access time domain resource is a remaining resource in the time window.

Optionally, the first communication device may perform retransmission random access based on the retransmission random access information.

Optionally, the first communication device may determine a resource for retransmission random access based on the information about the retransmission access resource, and perform retransmission random access on the resource for retransmission random access.

Optionally, the first communication device may determine, based on the information about the backoff time of retransmission random access, a backoff time range for initiating retransmission random access, determine, based on the backoff time range for initiating retransmission random access, a backoff time for initiating retransmission random access, and perform retransmission random access on a random access time domain resource after the backoff time for initiating retransmission random access.

Optionally, the first communication device may determine, based on the information about whether to fall back to the target random access manner, whether to perform retransmission random access by falling back, when the N times of triggered random access fails, to the manner in which the first communication device automatously initiates random access.

In some embodiments of this application, after the first communication device receives the first information, the method may further include the following steps:

Step 1: The first communication device receives second control information or third control information.

Step 2: The first communication device initiates initial transmission random access or retransmission random access based on the second control information.

The second control information is used to adjust a random access parameter. The third control information is used to confirm successful random access by the first communication device.

In this embodiment of this application, after sending the first information, the second communication device may further send the second control information or the third control information. After receiving the first information, the first communication device may further receive the second control information or the third control information.

In an embodiment, the first information includes the first control information. After the first communication device receives the first control information, the method may further include: The first communication device receives the second control information or the third control information.

The second control information is used to adjust the random access parameter, for example, adjust a random access parameter in the first control information, adjust a random access parameter in the first configuration information, adjust a random access parameter in the retransmission random access information, adjust a random access parameter currently applied by the first communication device, or adjust a random access parameter agreed upon in a protocol. Some or all of random access parameters may be adjusted.

For example, the random access congestion control information included in the first control information includes the random access index Q value, the second control information (which may be adjusted in a timely manner based on a collision situation) updates the Q value, and the first communication device that does not perform initial transmission random access or that has not been inventoried may select an initial transmission random access resource of the first communication device based on a new Q value.

For another example, the retransmission random access information includes the information about the retransmission random access resource, and the second control information (which may be adjusted in a timely manner based on a collision situation) updates a size, a range, and the like of the retransmission random access resource.

If the first communication device receives the second control information, it indicates that the random access parameter may need to be adjusted before random access is performed. The first communication device may initiate initial transmission random access or retransmission random access based on the second control information.

The third control information is used to confirm successful random access by the first communication device, is random access response information, and may carry identity information of the first communication device whose random access succeeds. If the first communication device receives the third control information, it may be determined that random access succeeds.

Optionally, the first communication device initiates initial transmission random access based on the second control information if the second control information is received before initial transmission random access is initiated. After the first communication device receives the first information, before random access is performed based on the first information, if the second control information is received, an adjusted random access parameter may be determined based on the second control information, and initial transmission random access may be initiated based on the adjusted random access parameter. This helps improve a random access success probability and improve inventory efficiency.

Optionally, the first communication device initiates retransmission random access based on the second control information if the second control information is received before initial transmission random access or retransmission random access succeeds. After the first communication device receives the first information, and random access is performed based on the first information, if the second control information is received before initial transmission random access or retransmission random access succeeds, an adjusted random access parameter may be determined based on the second control information, and retransmission random access may be initiated based on the adjusted random access parameter. This helps improve a random access success probability and improve inventory efficiency.

In some embodiments of this application, the second control information or the third control information is effective only in the current inventory process, or the second control information or the third control information is effective in the current inventory process and a subsequent inventory process.

If the second control information or the third control information is effective only in the current inventory process, when a new inventory process is triggered, the first communication device ignores second control information or third control information received in a previous inventory process.

If the second control information or the third control information is effective in the current inventory process and the subsequent inventory process, the first communication device may perform random access based on the second control information provided that the second control information is received, or the first communication device may determine, provided that the third control information is received, that random access succeeds.

For ease of understanding, the following further describes, by using a specific example, the technical solutions provided in the embodiments of this application.

A first communication device receives first information, and performs random access or makes an inventory response based on the first information.

The first information includes first configuration information, first control information, and retransmission random access information.

The first configuration information includes configuration information of random access time and frequency domain resources, for example, includes a period, duration, and a pattern of the random access resource. The first control information includes random access congestion control information. The random access congestion control information is used to indicate an available random access resource for the first communication device to initiate (first/initial transmission) random access.

In an embodiment, a network-side device separately configures (1) time and frequency resources used to automatously initiate random access by the first communication device and (2) time and frequency resources used to initiate random access by the first communication device by triggering.

The random access congestion control information specifically includes time domain congestion control information and frequency domain congestion control information.

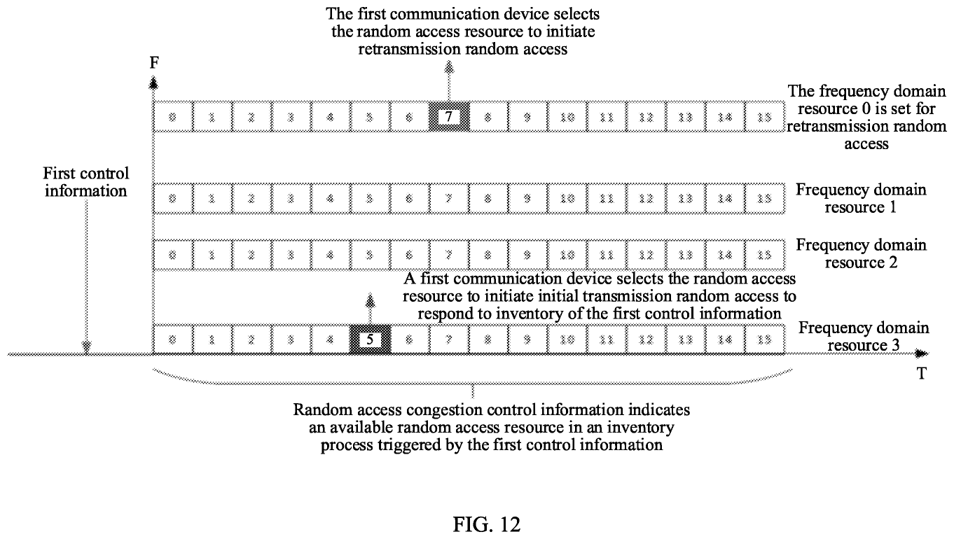

As shown in FIG. 12, in an embodiment, the time domain congestion control information includes a random access index Q, and Q=4. The first communication device determines, by using Q, that a corresponding random access time domain range is (0~2\hat{ }4−1), that is, (0~15), and randomly selects one slot from (0~15) slots (for example, a random access time unit is a slot) for access. For example, the first communication device selects a slot 5. The frequency domain congestion control information includes a random access frequency domain resource range, for example, indicates four optional random access carriers, so that the first communication device selects one optional random access carrier as a target random access carrier, and initiates random access on the target random access carrier. For example, the first communication device selects a carrier 3 to initiate random access.

In an embodiment, each block in FIG. 12 represents a random access occasion (RO), and 0~15 on one frequency domain resource represents 16 ROs. A resource of each RO is determined based on configuration information. For example, the configuration information indicates that a period is 2 ms, a time offset is 0 ms, and there is only one RO in each period. If the first control information is received at the 3rd ms, a first RO (RO 0) after the first control information is an RO located at the 4th ms.

Through comprehensive consideration of a random access time domain resource and a random access frequency domain resource, the first communication device initiates initial transmission random access in the slot 5 of the carrier 3 for the received first control information.

In an embodiment, the random access time and frequency domain resources are associatively selected. For example, only slots 0~5 can be selected on the carrier 3 to perform random access, and only slots 6~9 can be selected on a carrier 4 to perform random access. This configuration and the random access resource indication manner are not excluded in this embodiment of this application.

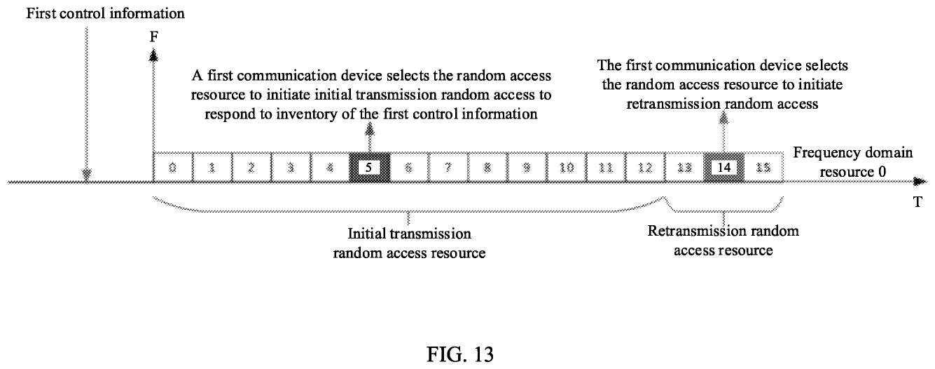

In an embodiment, the retransmission random access information includes information about retransmission random access time and frequency domain resources. The information about the retransmission random access time and frequency resources may be reserved by the network-side device for retransmission random access. For example, it is specified that a part of the available random access resource indicated in the random access congestion control information is reserved for retransmission random access. As shown in FIG. 13, with reference to the random access time domain range (0~15) indicated by Q=4, time domain resources of slot 13~slot 15 are specifically used to perform again random access by the first communication device whose initial transmission random access fails, that is, perform retransmission random access. In an embodiment, the first information includes a random access index Q and information about a retransmission random access resource. The information about the retransmission random access resource indicates that a resource reserved for retransmission random access is last M slots. After receiving the first control information, the first communication device can select a first inventory feedback resource (initial transmission random access resource) only from (0~2\hat{ }Q−1−M).

In an embodiment, optionally, the following may be agreed upon in a protocol or configured by the network-side device: When the first communication device fails to initiate N times of random access by triggering by the first control information (which may be understood as that N times of triggered random access fail), fallback to a manner in which the first communication device automatously initiates random access is implemented to perform random access. A value of N may be configured by the network-side device in the first configuration information or agreed upon in a protocol. This is not limited.

In another embodiment, the network-side device may configure the retransmission random access resource independently of the initial transmission random access resource. For example, in FIG. 12, the network-side device configures a frequency domain resource 0 for retransmission random access. The first communication device selects a time domain resource for performing retransmission random access from the frequency domain resource 0 in a specific manner. As shown in FIG. 12, the first communication device selects a slot 7 of the frequency domain resource 0 to perform retransmission random access.

In an embodiment, the network-side device or the protocol allows, when the retransmission random access resource is not independently configured, the first communication device to perform retransmission random access on a remaining random access resource in a random access resource corresponding to a current inventory process initiated by the first control information.

In an embodiment, the network-side device may configure a first communication device that performs initial transmission random access and a first communication device that performs retransmission random access to perform random access on different frequency domain resources to implement offloading, so as to reduce a collision probability and improve inventory efficiency.

In an embodiment, the network-side device sends the first control information to start an inventory round, and provides the random access congestion control information. The first control information may be carried through a paging shared channel/control channel or carried independently of a paging shared channel/control channel. The network-side device sends second control information to indicate congestion control information in this inventory process started by the first control information, to adjust a random access parameter. Optionally, the network-side device further indicates retransmission random access information. The retransmission random access information is carried through a paging shared channel/control channel or carried independently of a paging shared channel/control channel. The shared channels/control channels carrying the first control information, the second control information, and the retransmission random access information belong to a same resource set (the network-side device configures one resource set for the shared channels/control channels of the first control information, the second control information, and the retransmission random access information), or different resource sets (the network-side device respectively configures resource sets for the shared channels/control channels of the first control information, the second control information, and retransmission random access).

The first communication device monitors the first control information, the second control information, or the retransmission random access information. The first communication device determines, based on a random access resource (for example, Msg 1/Msg A RACH resource configuration in an NR system) provided in the first configuration information, the first control information, the second control information, or the retransmission random access information, a resource for random access by the first communication device.

Specifically, at least one of the following cases may be included:

After receiving the first control information, the first communication device initiates random access, but temporarily does not receive third control information, where the third control information is used to indicate whether random access by the first communication device succeeds, and the first communication device receives the second control information.

After the first communication device receives the second control information, if successful access is confirmed (for example, the first communication device receives the third control information), no response to the second control information is made.

After the first communication device receives the second control information, if unsuccessful access is confirmed (for example, no access success confirmation sent by the network-side device is received in a response waiting window for random access, or an unsuccessful access indication sent by the network-side device is received), next random access (which may be understood as retransmission random access) may be performed based on the second control information.

After receiving the first control information, the first communication device temporarily does not initiate initial transmission random access (for example, the first communication device has not sent an uplink signal of random access for the first time). The first communication device receives the second control information, and the first communication device initiates initial transmission random access based on congestion control information in the second control information.

A corresponding indication in the second control information is effective only for a first communication device whose access does not succeed, including a case that the first communication device confirms unsuccessful access but has not performed retransmission random access or the first communication device has not performed initial transmission random access.

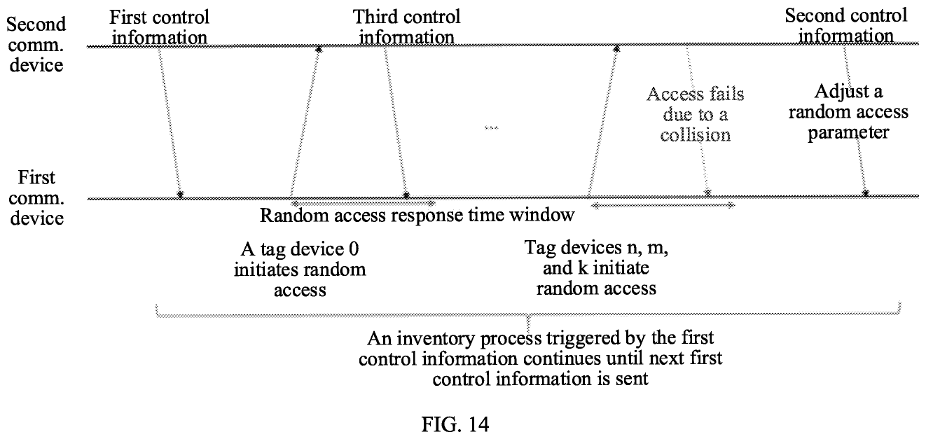

As shown in FIG. 14, a second communication device, such as a network-side device, may select a group of first communication devices to be inventoried, send first control information to trigger an inventory process, and carry random access congestion control information. The first communication device, such as tag devices 0, n, m, and k, initiates random access, sends RN16 temporary identity information or directly sends an electronic product code EPC, and then waits for receiving information confirming successful access. The second communication device sends third control information to a first communication device whose access succeeds. If the tag device 0 receives the third control information and confirms successful access, the tag devices n, m, and k fail to receive the third control information due to a collision. If second control information is received, the second control information is used to adjust a random access parameter. The inventory process triggered by the first control information continues until next first control information is sent.

In an inventory process, the network-side device may send the second control information one or more times. Similarly, the first communication device may determine, based on whether random access is performed before latest second control information is received and whether an access success confirmation is received, whether to perform next random access based on the latest received second control information.

Optionally, after the first communication device sends a random access signal on a random access resource, if the first communication device receives the third control information, where the third control information includes congestion control information but does not include access success confirmation information for the first communication device, the first communication device performs next random access based on the third control information.

Optionally, after the first communication device sends a random access signal on a random access resource, if the first communication device receives the second control information and the third control information, where the third control information includes congestion control information but does not include access success confirmation information for the first communication device, the first communication device performs next random access based on the second control information or the third control information. For example, if the second control information and the third control information indicate a same congestion control parameter but different values, the random access parameter is determined based on an indication of the third control information. For another example, the parameter is determined based on control information received later in the second control information and the third control information, to perform next random access.

It should be noted that both the second control information and the third control information may carry congestion control information. However, a difference between the second control information and the third control information lies in that the second control information and the third control information are oriented to different objects. The second control information is oriented to all first communication devices that are to be inventoried and that are determined based on the first control information (certainly there is a first communication device that can be used and a first communication device that cannot be used), and the third control information is oriented to a first communication device that initiates random access on an associated random access resource (for example, an associated RO).

In this example, the first communication device is an ambient internet of things device. The network-side device is an example of the second communication device that communicates with the first communication device. In addition, the second communication device may be an intermediate node. For example, a terminal communicates with the first communication device as the second communication device. The second communication device is a device that sends the first control information.

The technical solutions provided in the embodiments of this application are applicable to ultra-low-end internet of things applications, and participating ambient internet of things devices are ultra-low-complexity and ultra-low-power terminals. A related design of random access control for an ambient internet of things device is implemented in a 3GPP NR framework. According to an inventory design in a current RFID protocol, if an ambient internet of things device fails to send inventory feedback for the first time, the ambient internet of things device can only exit a current inventory process, wait for a new round of inventory reinitiated by a reader, and then attempt access again. In this manner, an inventory delay of an ambient internet of things device whose initial transmission random access fails is increased, and inventory efficiency is reduced. In the embodiments of this application, based on the 3GPP NR random access design, a congestion control mechanism is designed for ambient internet of things devices performing initial transmission random access and retransmission random access (random access may be understood as inventory feedback), to reduce an inventory collision and improve inventory efficiency.

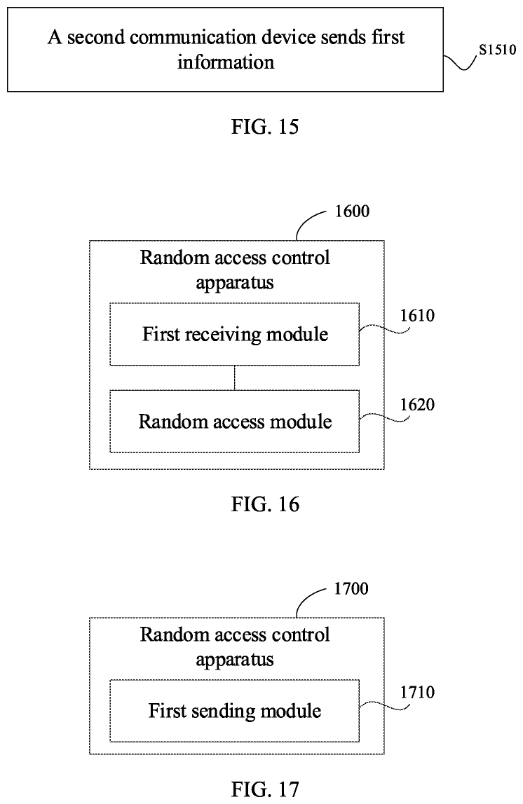

Corresponding to the foregoing method embodiments, an embodiment of this application further provides a random access control method. As shown in FIG. 15, the method includes the following steps.

S1510: A second communication device sends first information.

The first information includes first configuration information or first control information.

The first configuration information is used to indicate configuration information of random access.

The first control information is used to trigger a first communication device to initiate random access, or is used to initiate an inventory process.

According to the method provided in this embodiment of this application, the second communication device sends the first information. The first information includes the first configuration information or the first control information. The first configuration information is used to indicate the configuration information of random access. The first control information is used to trigger the first communication device to initiate random access, or is used to initiate an inventory process. Random access control for the first communication device is implemented by using the first information. This helps reduce an inventory collision and improve inventory efficiency.

In some embodiments of this application, the first configuration information includes at least one of the following:
configuration information of a random access time domain resource;
configuration information of a random access frequency domain resource;
configuration information of a random access code domain resource;
information about a random access type associated with a random access resource; and
information about a random access type supported by a cell.

In some embodiments of this application, the random access type includes at least one of the following:
a manner of initiating random access;
a service type of random access; and
a session type of random access.

The manner of initiating random access includes random access automatously initiated by the first communication device or random access initiated by the first communication device by triggering. The service type of random access includes random access of an inventory service or random access of a non-inventory service.

In some embodiments of this application, the first control information includes random access congestion control information, and the random access congestion control information is used to indicate an available random access resource.

In some embodiments of this application, a part or all of the available random access resource is used for retransmission random access or initial transmission random access.

In some embodiments of this application, the random access congestion control information includes at least one of time domain congestion control information, frequency domain congestion control information, or code domain congestion control information.

The time domain congestion control information includes at least one of the following:
a random access index, where the random access index is used to indicate a random access time domain range;
inventory time window information, where the inventory time window information is used to indicate a time range for initiating random access; and
backoff time information, where the backoff time information is used to indicate a backoff time range for initiating random access.

The frequency domain congestion control information includes a random access frequency domain resource range.

The code domain congestion control information includes a random access code domain resource range.

In some embodiments of this application, the first information further includes retransmission random access information, and the retransmission random access information includes at least one of the following:
information about a retransmission random access resource, where the information about the retransmission random access resource is used to indicate a resource for retransmission random access;
information about a backoff time of retransmission random access, where the information about the backoff time of retransmission random access is used to indicate a backoff time range for initiating retransmission random access;
information about whether to fall back to a target random access manner; and
information about whether it is allowed to initiate retransmission random access in an inventory process.

In some embodiments of this application, the retransmission random access resource includes a remaining random access resource, other than a resource used for initial transmission random access, in a random access resource corresponding to a current inventory process.

In some embodiments of this application, a start reference point of the backoff time of retransmission random access includes a start or end location of a resource set for initial transmission random access, an end location of a time unit in which initial transmission random access by the first communication device fails, or an end location of a random access response time window.

In some embodiments of this application, after the second communication device sends the first information, the method further includes:

The second communication device sends second control information or third control information.

The second control information is used to adjust a random access parameter. The third control information is used to confirm successful random access by the first communication device.

In some embodiments of this application, the second control information or the third control information is effective only in the current inventory process, or the second control information or the third control information is effective in the current inventory process and a subsequent inventory process.

The random access control method provided in this embodiment of this application can implement the processes implemented in the method embodiments shown in FIG. 11 to FIG. 14, and achieve same technical effects. To avoid repetition, details are not described herein.

The random access control method provided in the embodiments of this application may be performed by a random access control apparatus. In the embodiments of this application, a random access control apparatus provided in the embodiments of this application is described by using an example in which the random access control apparatus performs the random access control method.

As shown in FIG. 16, a random access control apparatus 1600 includes the following modules:
a first receiving module 1610, configured to receive first information; and
a random access module 1620, configured to perform random access based on the first information.

The first information includes first configuration information or first control information.

The first configuration information is used to indicate configuration information of random access.

The first control information is used to trigger a first communication device to initiate random access, or is used to initiate an inventory process.

After receiving the first information, the apparatus provided in this embodiment of this application performs random access based on the first information. The first information includes the first configuration information or the first control information. The first configuration information is used to indicate the configuration information of random access. The first control information is used to trigger the first communication device to initiate random access, or is used to initiate an inventory process. Random access control for the first communication device is implemented by using the first information. This helps reduce an inventory collision and improve inventory efficiency.

In some embodiments of this application, the first configuration information includes at least one of the following:
configuration information of a random access time domain resource;
configuration information of a random access frequency domain resource;
configuration information of a random access code domain resource;
information about a random access type associated with a random access resource; and
information about a random access type supported by a cell.

In some embodiments of this application, the random access type includes at least one of the following:
a manner of initiating random access;
a service type of random access; and
a session type of random access.

The manner of initiating random access includes random access automatously initiated by the first communication device or random access initiated by the first communication device by triggering. The service type of random access includes random access of an inventory service or random access of a non-inventory service.

In some embodiments of this application, the first control information includes random access congestion control information, and the random access congestion control information is used to indicate an available random access resource.

In some embodiments of this application, a part or all of the available random access resource is used for retransmission random access or initial transmission random access.

In some embodiments of this application, the random access congestion control information includes at least one of time domain congestion control information, frequency domain congestion control information, or code domain congestion control information.

The time domain congestion control information includes at least one of the following:
a random access index, where the random access index is used to indicate a random access time domain range;
inventory time window information, where the inventory time window information is used to indicate a time range for initiating random access; and
backoff time information, where the backoff time information is used to indicate a backoff time range for initiating random access.

The frequency domain congestion control information includes a random access frequency domain resource range.

The code domain congestion control information includes a random access code domain resource range.

In some embodiments of this application, the random access module 1620 is configured to:
determine the available random access resource based on the random access congestion control information;
determine a target random access resource from the available random access resource in a first manner; and
initiate random access on the target random access resource.

The first manner includes a random selection manner or a manner associated with an identifier of the first communication device.

In some embodiments of this application, the first information further includes retransmission random access information, and the retransmission random access information includes at least one of the following:
information about a retransmission random access resource, where the information about the retransmission random access resource is used to indicate a resource for retransmission random access;
information about a backoff time of retransmission random access, where the information about the backoff time of retransmission random access is used to indicate a backoff time range for initiating retransmission random access;
information about whether to fall back to a target random access manner; and
information about whether it is allowed to initiate retransmission random access in an inventory process.

In some embodiments of this application, the retransmission random access resource includes a remaining random access resource, other than a resource used for initial transmission random access, in a random access resource corresponding to a current inventory process.

In some embodiments of this application, a start reference point of the backoff time of retransmission random access includes a start or end location of a resource set for initial transmission random access, an end location of a time unit in which initial transmission random access by the first communication device fails, or an end location of a random access response time window.

In some embodiments of this application, the random access control apparatus 1600 further includes an exit module or a retransmission module.

The exit module is configured to: after random access is performed based on the first information, when random access fails, exit the inventory process initiated by triggering by the first control information.

The retransmission module is configured to: after random access is performed based on the first information, when random access fails, initiate retransmission random access.

In some embodiments of this application, the retransmission module is configured to:
fall back to initiating retransmission random access in the target random access manner.

In some embodiments of this application, the retransmission module is configured to:
when N times of random access fail to be initiated, fall back to initiating retransmission random access in the target random access manner, where N is a positive integer greater than or equal to 1.

In some embodiments of this application, the target random access manner includes a manner in which the first communication device automatously initiates random access.

In some embodiments of this application, the random access control apparatus 1600 further includes a second receiving module, configured to:
receive second control information or third control information after the first information is received; and
initiate initial transmission random access or retransmission random access based on the second control information.

The second control information is used to adjust a random access parameter. The third control information is used to confirm successful random access by the first communication device.

In some embodiments of this application, the second receiving module is configured to:
initiate initial transmission random access based on the second control information if the second control information is received before initial transmission random access is initiated; or
initiate retransmission random access based on the second control information if the second control information is received before initial transmission random access or retransmission random access succeeds.

In some embodiments of this application, the second control information or the third control information is effective only in the current inventory process, or the second control information or the third control information is effective in the current inventory process and a subsequent inventory process.

The random access control apparatus 1600 provided in this embodiment of this application can implement the processes implemented in the method embodiments shown in FIG. 11 to FIG. 14, and achieve same technical effects. To avoid repetition, details are not described herein.

As shown in FIG. 17, a random access control apparatus 1700 includes the following module:
a first sending module 1700, configured to send first information.

The first information includes first configuration information or first control information.

The first configuration information is used to indicate configuration information of random access.

The first control information is used to trigger a first communication device to initiate random access, or is used to initiate an inventory process.

The apparatus provided in this embodiment of this application sends first information. The first information includes the first configuration information or the first control information. The first configuration information is used to indicate the configuration information of random access. The first control information is used to trigger the first communication device to initiate random access, or is used to initiate an inventory process. Random access control for the first communication device is implemented by using the first information. This helps reduce an inventory collision and improve inventory efficiency.

In some embodiments of this application, the first configuration information includes at least one of the following:
configuration information of a random access time domain resource;
configuration information of a random access frequency domain resource;
configuration information of a random access code domain resource;
information about a random access type associated with a random access resource; and
information about a random access type supported by a cell.

In some embodiments of this application, the random access type includes at least one of the following:
a manner of initiating random access;
a service type of random access; and
a session type of random access.

The manner of initiating random access includes random access automatously initiated by the first communication device or random access initiated by the first communication device by triggering. The service type of random access includes random access of an inventory service or random access of a non-inventory service.

In some embodiments of this application, the first control information includes random access congestion control information, and the random access congestion control information is used to indicate an available random access resource.

In some embodiments of this application, a part or all of the available random access resource is used for retransmission random access or initial transmission random access.

In some embodiments of this application, the random access congestion control information includes at least one of time domain congestion control information, frequency domain congestion control information, or code domain congestion control information.

The time domain congestion control information includes at least one of the following:
a random access index, where the random access index is used to indicate a random access time domain range;
inventory time window information, where the inventory time window information is used to indicate a time range for initiating random access; and
backoff time information, where the backoff time information is used to indicate a backoff time range for initiating random access.

The frequency domain congestion control information includes a random access frequency domain resource range.

The code domain congestion control information includes a random access code domain resource range.

In some embodiments of this application, the first information further includes retransmission random access information, and the retransmission random access information includes at least one of the following:
information about a retransmission random access resource, where the information about the retransmission random access resource is used to indicate a resource for retransmission random access;
information about a backoff time of retransmission random access, where the information about the backoff time of retransmission random access is used to indicate a backoff time range for initiating retransmission random access;
information about whether to fall back to a target random access manner; and
information about whether it is allowed to initiate retransmission random access in an inventory process.

In some embodiments of this application, the retransmission random access resource includes a remaining random access resource, other than a resource used for initial transmission random access, in a random access resource corresponding to a current inventory process.

In some embodiments of this application, a start reference point of the backoff time of retransmission random access includes a start or end location of a resource set for initial transmission random access, an end location of a time unit in which initial transmission random access by the first communication device fails, or an end location of a random access response time window.

In some embodiments of this application, the random access control apparatus 1700 further includes a second sending module, configured to:
send second control information or third control information after the first information is sent.

The second control information is used to adjust a random access parameter. The third control information is used to confirm successful random access by the first communication device.

In some embodiments of this application, the second control information or the third control information is effective only in the current inventory process, or the second control information or the third control information is effective in the current inventory process and a subsequent inventory process.

The random access control apparatus 1700 provided in this embodiment of this application can implement the processes implemented in the method embodiments shown in FIG. 12 to FIG. 15, and achieve same technical effects. To avoid repetition, details are not described herein.

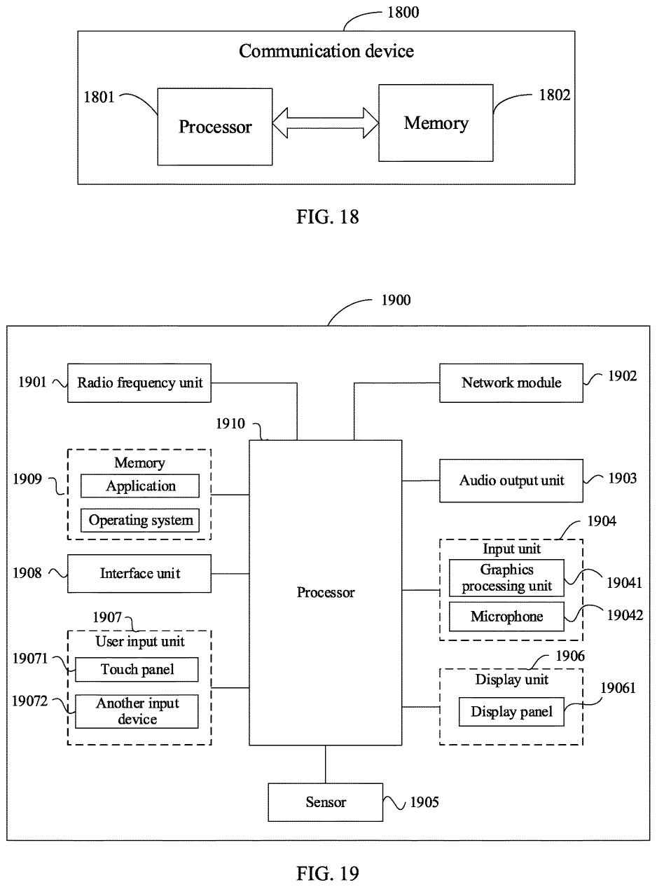

As shown in FIG. 18, an embodiment of this application further provides a communication device 1800, including a processor 1801 and a memory 1802. The memory 1802 stores a program or instructions capable of running on the processor 1801. For example, when the communication device 1800 is a first communication device, the program or the instructions are executed by the processor 1801 to implement the steps in the method embodiments shown in FIG. 11 to FIG. 14, and same technical effects can be achieved. When the communication device 1800 is a second communication device, the program or the instructions are executed by the processor 1801 to implement the steps in the method embodiments shown in FIG. 12 to FIG. 15, and same technical effects can be achieved. To avoid repetition, details are not described herein.

An embodiment of this application further provides a terminal, including a processor and a communication interface. The communication interface is coupled to the processor. The processor is configured to run a program or instructions to implement the steps in the method embodiments shown in FIG. 12 to FIG. 15. The terminal embodiment corresponds to the method embodiment on the second communication device side. Each implementation process and implementation of the method embodiment on the second communication device side may be applied to the terminal embodiment, and same technical effects can be achieved.

Specifically, FIG. 19 is a schematic diagram of a structure of a terminal for implementing an embodiment of this application.

The terminal 1900 includes but is not limited to at least some components in a radio frequency unit 1901, a network module 1902, an audio output unit 1903, an input unit 1904, a sensor 1905, a display unit 1906, a user input unit 1907, an interface unit 1908, a memory 1909, a processor 1910, and the like.

A person skilled in the art may understand that the terminal 1900 may further include a power supply (for example, a battery) that supplies power to each component. The power supply may be logically connected to the processor 1910 through a power management system, to implement functions such as charging management, discharging management, and power consumption management through the power management system. The structure of the terminal shown in FIG. 19 does not constitute a limitation on the terminal. The terminal may include more or fewer components than those shown in the figure, or combine some components, or have different component arrangements. Details are not described herein.

It should be understood that in this embodiment of this application, the input unit 1904 may include a graphics processing unit (GPU) 19041 and a microphone 19042. The graphics processing unit 19041 processes image data of a still picture or a video obtained by an image capture apparatus (such as a camera) in a video capture mode or an image capture mode. The display unit 1906 may include a display panel 19061, and the display panel 19061 may be configured in a form of a liquid crystal display, an organic light-emitting diode, or the like. The user input unit 1907 includes at least one of a touch panel 19071 and another input device 19072. The touch panel 19071 is also referred to as a touchscreen. The touch panel 19071 may include two parts: a touch detection apparatus and a touch controller. The another input device 19072 may include but is not limited to a physical keyboard, a function key (such as a volume control key or an on/off key), a trackball, a mouse, and a joystick. Details are not described herein.

In this embodiment of this application, after receiving downlink data from a network-side device, the radio frequency unit 1901 may transmit the downlink data to the processor 1910 for processing. In addition, the radio frequency unit 1901 may send uplink data to the network-side device. Usually, the radio frequency unit 1901 includes but is not limited to an antenna, an amplifier, a transceiver, a coupler, a low-noise amplifier, a duplexer, and the like.

The memory 1909 may be configured to store a software program or instructions and various types of data. The memory 1909 may mainly include a first storage area for storing a program or instructions and a second storage area for storing data. The first storage area may store an operating system, an application or instructions required by at least one function (for example, a sound play function or an image play function), and the like. In addition, the memory 1909 may include a volatile memory or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synch link dynamic random access memory (SLDRAM), and a direct rambus random access memory (DRRAM). The memory 1909 in this embodiment of this application includes but is not limited to these memories and any other suitable type of memory.

The processor 1910 may include one or more processing units. Optionally, the processor 1910 integrates an application processor and a modem processor. The application processor mainly processes operations related to an operating system, a user interface, an application program, and the like. The modem processor, for example, a baseband processor, mainly processes a wireless communication signal. It may be understood that the modem processor may not be integrated into the processor 1910.

It may be understood that for implementation processes of the implementations in this embodiment, refer to related descriptions in the method embodiments shown in FIG. 12 to FIG. 15, and same or corresponding technical effects are achieved. To avoid repetition, details are not described herein.

An embodiment of this application further provides a network-side device, including a processor and a communication interface. The communication interface is coupled to the processor. The processor is configured to run a program or instructions to implement the steps in the method embodiments shown in FIG. 12 to FIG. 15. The network-side device embodiment corresponds to the method embodiment on the second communication device side. Each implementation process and implementation of the method embodiment on the second communication device side may be applied to the network-side device embodiment, and same technical effects can be achieved.

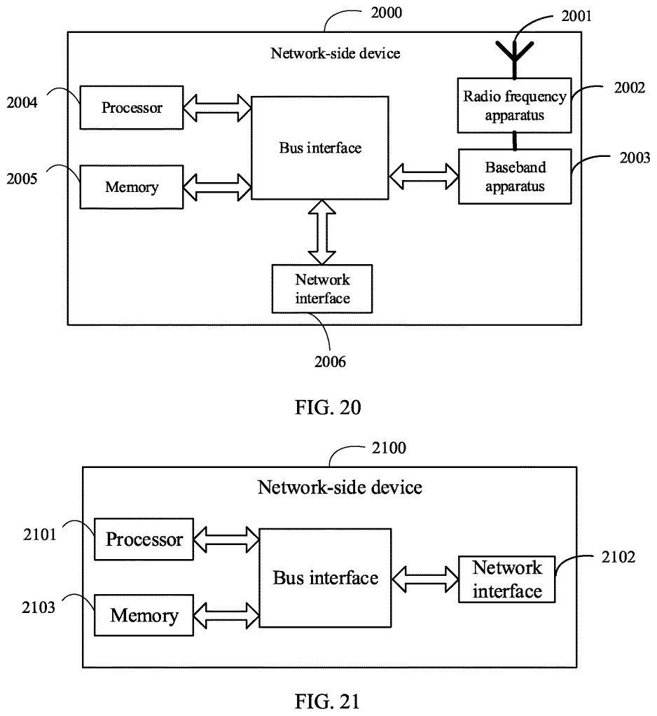

Specifically, an embodiment of this application further provides a network-side device. As shown in FIG. 20, the network-side device 2000 includes an antenna 2001, a radio frequency apparatus 2002, a baseband apparatus 2003, a processor 2004, and a memory 2005. The antenna 2001 is connected to the radio frequency apparatus 2002. In an uplink direction, the radio frequency apparatus 2002 receives information through the antenna 2001, and sends the received information to the baseband apparatus 2003 for processing. In a downlink direction, the baseband apparatus 2003 processes to-be-sent information, and sends processed information to the radio frequency apparatus 2002. The radio frequency apparatus 2002 processes the received information, and then sends processed information through the antenna 2001.

The method performed by the network-side device in the foregoing embodiments may be implemented in the baseband apparatus 2003. The baseband apparatus 2003 includes a baseband processor.

For example, the baseband apparatus 2003 may include at least one baseband board. A plurality of chips are disposed on the baseband board. As shown in FIG. 20, one of the chips is, for example, the baseband processor, and is connected to the memory 2005 through a bus interface, to invoke a program in the memory 2005 to perform the operations of the network-side device shown in the foregoing method embodiments.

The network-side device may further include a network interface 2006, and the interface is, for example, a common public radio interface (CPRI).

Specifically, the network-side device 2000 in this embodiment of this application further includes instructions or a program stored in the memory 2005 and capable of running on the processor 2004. The processor 2004 invokes the instructions or the program in the memory 2005 to perform the method performed by the modules shown in FIG. 17, and same technical effects are achieved. To avoid repetition, details are not described herein.

Specifically, an embodiment of this application further provides a network-side device. As shown in FIG. 21, the network-side device 2100 includes a processor 2101, a network interface 2102, and a memory 2103. The network interface 2102 is, for example, a common public radio interface (CPRI).

Specifically, the network-side device 2100 in this embodiment of this application further includes instructions or a program stored in the memory 2103 and capable of running on the processor 2101. The processor 2101 invokes the instructions or the program in the memory 2103 to perform the method performed by the modules shown in FIG. 17, and same technical effects are achieved. To avoid repetition, details are not described herein.

An embodiment of this application further provides a readable storage medium. The readable storage medium stores a program or instructions. The program or the instructions are executed by a processor to implement the processes in the foregoing embodiments of the random access control method, and same technical effects can be achieved. To avoid repetition, details are not described herein.

The processor is a processor in the terminal described in the foregoing embodiments. The readable storage medium includes a computer-readable storage medium, such as a computer read-only memory ROM, a random access memory RAM, a magnetic disk, or an optical disc. In some examples, the readable storage medium may be a non-transitory readable storage medium.

An embodiment of this application further provides a chip. The chip includes a processor and a communication interface. The communication interface is coupled to the processor. The processor is configured to run a program or instructions to implement the processes in the foregoing embodiments of the random access control method, and same technical effects can be achieved. To avoid repetition, details are not described herein.

It should be understood that the chip in this embodiment of this application may also be referred to as a system-level chip, a system chip, a chip system, a system on chip, or the like.

An embodiment of this application further provides a computer program/program product. The computer program/program product is stored in a storage medium, and the computer program/program product is executed by at least one processor to implement the processes in the foregoing embodiments of the random access control method, and same technical effects can be achieved. To avoid repetition, details are not described herein.

An embodiment of this application further provides a wireless communication system, including a first communication device and a second communication device. The first communication device may be configured to perform the steps in the method embodiments shown in FIG. 11 to FIG. 14, and the second communication device may be configured to perform the steps in the method embodiments shown in FIG. 12 to FIG. 15.

It should be noted that in this specification, the term “include”, “comprise”, or any other variants thereof is intended to cover a non-exclusive inclusion, so that a process, a method, an article, or an apparatus that includes a list of elements not only includes those elements but also includes other elements that are not expressly listed, or further includes elements inherent to such a process, method, article, or apparatus. Without more limitations, an element preceded by “includes a . . . ” does not preclude the existence of additional identical elements in the process, method, article, or apparatus that includes the element. In addition, it should be noted that the scope of the methods and apparatuses in the implementations of this application is not limited to performing functions in a sequence shown or discussed, and may further include performing functions in a basically simultaneous manner or in a reverse sequence based on related functions. For example, the described methods may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc), and includes several instructions for enabling a terminal or a network-side device to perform the method in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from the principle of this application and the protection scope of the claims, and all these implementations fall within the protection scope of this application.

1. A random access control method, comprising:
receiving, by a first communication device, first information; and
performing, by the first communication device, random access based on the first information, wherein
the first information comprises first configuration information or first control information;
the first configuration information is used to indicate configuration information of random access, wherein the first configuration information comprises at least one of the following:
configuration information of a random access time domain resource; configuration information of a random access frequency domain resource; configuration information of a random access code domain resource; information about a random access type associated with a random access resource; and information about a random access type supported by a cell; and
the first control information is used to trigger the first communication device to initiate random access, or is used to initiate an inventory process, wherein the first control information comprises random access congestion control information, and the random access congestion control information is used to indicate an available random access resource.

2. The method according to claim 1, wherein the random access type comprises at least one of the following:
a manner of initiating random access;
a service type of random access; and
a session type of random access, wherein
the manner of initiating random access comprises random access automatously initiated by the first communication device or random access initiated by the first communication device by triggering; and the service type of random access comprises random access of an inventory service or random access of a non-inventory service.

3. The method according to claim 1, wherein a part or all of the available random access resource is used for retransmission random access or initial transmission random access.

4. The method according to claim 1, wherein the random access congestion control information comprises at least one of time domain congestion control information, frequency domain congestion control information, or code domain congestion control information;
the time domain congestion control information comprises at least one of the following:
a random access index, wherein the random access index is used to indicate a random access time domain range;
inventory time window information, wherein the inventory time window information is used to indicate a time range for initiating random access; and
backoff time information, wherein the backoff time information is used to indicate a backoff time range for initiating random access;
the frequency domain congestion control information comprises a random access frequency domain resource range; and
the code domain congestion control information comprises a random access code domain resource range.

5. The method according to claim 1, wherein the performing, by the first communication device, random access based on the first information comprises:
determining, by the first communication device, the available random access resource based on the random access congestion control information;
determining, by the first communication device, a target random access resource from the available random access resource in a first manner; and
initiating, by the first communication device, random access on the target random access resource, wherein
the first manner comprises a random selection manner or a manner associated with an identifier of the first communication device.

6. The method according to claim 1, wherein the first information further comprises retransmission random access information, and the retransmission random access information comprises at least one of the following:
information about a retransmission random access resource, wherein the information about the retransmission random access resource is used to indicate a resource for retransmission random access;
information about a backoff time of retransmission random access, wherein the information about the backoff time of retransmission random access is used to indicate a backoff time range for initiating retransmission random access;
information about whether to fall back to a target random access manner; and
information about whether it is allowed to initiate retransmission random access in an inventory process.

7. The method according to claim 6, wherein the retransmission random access resource comprises a remaining random access resource, other than a resource used for initial transmission random access, in a random access resource corresponding to a current inventory process.

8. The method according to claim 6, wherein a start reference point of the backoff time of retransmission random access comprises a start or end location of a resource set for initial transmission random access, an end location of a time unit in which initial transmission random access by the first communication device fails, or an end location of a random access response time window.

9. The method according to claim 1, wherein after the performing, by the first communication device, random access based on the first information, the method further comprises:
when random access fails, exiting, by the first communication device, the inventory process initiated by triggering by the first control information, or initiating, by the first communication device, retransmission random access.

10. The method according to claim 9, wherein the initiating, by the first communication device, retransmission random access comprises:
falling back, by the first communication device, to initiating retransmission random access in the target random access manner.

11. The method according to claim 10, wherein the falling back, by the first communication device, to initiating retransmission random access in the target random access manner comprises:
when N times of random access fail to be initiated, falling back, by the first communication device, to initiating retransmission random access in the target random access manner, wherein N is a positive integer greater than or equal to 1.

12. The method according to claim 6, wherein the target random access manner comprises a manner in which the first communication device automatously initiates random access.

13. The method according to claim 1, wherein after the receiving, by a first communication device, first information, the method further comprises:
receiving, by the first communication device, second control information or third control information; and
initiating, by the first communication device, initial transmission random access or retransmission random access based on the second control information, wherein
the second control information is used to adjust a random access parameter, and the third control information is used to confirm successful random access by the first communication device.

14. The method according to claim 13, wherein the initiating, by the first communication device, initial transmission random access or retransmission random access based on the second control information comprises:
initiating, by the first communication device, initial transmission random access based on the second control information if the second control information is received before initial transmission random access is initiated; or
initiating, by the first communication device, retransmission random access based on the second control information if the second control information is received before initial transmission random access or retransmission random access succeeds.

15. The method according to claim 13, wherein the second control information or the third control information is effective only in the current inventory process, or the second control information or the third control information is effective in the current inventory process and a subsequent inventory process.

16. A random access control method, comprising:
sending, by a second communication device, first information, wherein
the first information comprises first configuration information or first control information;
the first configuration information is used to indicate configuration information of random access, wherein the first configuration information comprises at least one of the following:
configuration information of a random access time domain resource; configuration information of a random access frequency domain resource; configuration information of a random access code domain resource; information about a random access type associated with a random access resource; and information about a random access type supported by a cell; and
the first control information is used to trigger a first communication device to initiate random access, or is used to initiate an inventory process, wherein the first control information comprises random access congestion control information, and the random access congestion control information is used to indicate an available random access resource.

17. The method according to claim 16, wherein the random access type comprises at least one of the following:
a manner of initiating random access;
a service type of random access; and
a session type of random access, wherein
the manner of initiating random access comprises random access automatously initiated by the first communication device or random access initiated by the first communication device by triggering; and the service type of random access comprises random access of an inventory service or random access of a non-inventory service.

18. The method according to claim 16, wherein a part or all of the available random access resource is used for retransmission random access or initial transmission random access.

19. A communication device, comprising a processor and a memory, wherein the memory stores a program or instructions capable of running on the processor, and the program or the instructions, when executed by the processor, implement a random access control method, comprising:
receiving first information; and
performing random access based on the first information, wherein
the first information comprises first configuration information or first control information;
the first configuration information is used to indicate configuration information of random access, wherein the first configuration information comprises at least one of the following: configuration information of a random access time domain resource; configuration information of a random access frequency domain resource; configuration information of a random access code domain resource; information about a random access type associated with a random access resource; and information about a random access type supported by a cell; and
the first control information is used to trigger the first communication device to initiate random access, or is used to initiate an inventory process, wherein the first control information comprises random access congestion control information, and the random access congestion control information is used to indicate an available random access resource.

20. A communication device, comprising a processor and a memory, wherein the memory stores a program or instructions capable of running on the processor, and the program or the instructions are executed by the processor to implement the steps of the random access control method according to claim 16.
